(19) United States
(12) Patent Application Publication
(10) Pub. No.: US 2002/0020226 A1
(43) Pub. Date: Feb. 21, 2002

(54) Scale indication apparatus and flow meter having the same

(76) Inventors: Kunio Kido, Tokyo (JP); Yoshiyuki Matsuoka, Tokyo (JP); Masaaki Okano, Aichi (JP); Atsushi Hatakeyama, Tokyo (JP)

Correspondence Address: NOTARO & MICHALOS P.C., Suite 110, 100 Dutch Hill Road, Orangeburg, NY, 10962-2100, US

(21) Appl. No.: 09/823,048

(22) Filed: Mar. 30, 2001

(30) Foreign Application Priority Data
Mar. 31, 2000 (JP) 2000-97263

(51) Int. Cl. G01F 1/07

(52) U.S. Cl. 73/861.88

(57) ABSTRACT

A scale indication apparatus and a flow meter having the scale indication apparatus, which improve the usability and the versatility. The scale indication apparatus (31) is rotatably attached to a measurement apparatus (1) which can not be externally operated and indicates a scale when reading the displacement magnitude of an indicator (19) of the measurement apparatus (1). A scale indication position can be sequentially moved to reset the displacement magnitude of the indicator (19) by the rotating operation in a first direction without movement in an axial direction, and the scale indication apparatus (31) can be moved in the axial direction to be detached from the measurement apparatus (1) by the rotating operation in a second direction opposite from the first direction.

### FIELD OF THE INVENTION

The present invention relates to a scale indication apparatus and a flow meter having this apparatus. More particularly, the present invention relates to a scale indication apparatus which is attached to a measurement apparatus for outputting a measured value as the displacement magnitude of an indicator and indicates a scale used for reading the displacement magnitude of the indicator, and a flow meter having this scale indication apparatus.

### BACKGROUND OF THE INVENTION

Conventionally, in a flow meter incorporated in a domestic water purifier, its casing is molded by, e.g., transparent plastic, and rotational displacement of a gear in a last stage of a built-in speed reduction gear train can be seen from outside to confirm an integrated flow quantity so that a replacement timing for a filter cartridge of the water purifier is notified. That is, an impeller is rotated by water flowing through a flow path in the casing, and the speed of this rotation is reduced by the speed reduction gear train, thereby detecting an integrated flow quantity subjected to a water purifying process from the rotational displacement magnitude of the gear in the last stage. A mark such as a hole is provided to the gear in the last stage, and the rotational displacement magnitude of the gear is read by associating a position of this mark to a scale provided to the casing. In the structure that the scale is provided directly to the casing as described above, it is impossible to move a position of the scale or replace the scale with another scale. Furthermore, the gear in the last stage which serves as a so-called indicator can not be detached from a gear in any other stage to be independent from the rotating impeller in order to effect the rotational displacement.

In the above-mentioned flow meter, however, the scale provided to the casing must be changed in case of varying an integrated flow quantity to be measured. In particular, if the scale is directly engraved to the casing, the casing must be changed, and hence the allowance can not be provided to an integrated flow quantity to be measured.

Moreover, when repeatedly measuring a predetermined flow quantity, since a scale indicative of an end position of previous measurement corresponds to a scale indicative of a start position of next measurement. Thus, if end of measurement is erred in the previous measurement and the mark provided to the gear in the last stage overruns beyond the scale position, the start position of next measurement can not be matched with the scale, and accurate measurement becomes difficult. In particular, in the flow meter used in a domestic water purifier, an integrated flow quantity must be repeatedly and continuously measured in order to be aware of cartridge replacement timing. If the timing for cartridge replacement is once upset, the mark indicative of the rotational displacement magnitude of the gear in the last stage thereafter does not match with the position of the scale provided to the casing, which makes it difficult to be correctly aware of the cartridge replacement timing, thereby deteriorating the usability.

In addition, since the positional relationship between the mark of the gear in the last stage and the scale of a cover can not be adjusted, arbitrary setting of a measurement start position, e.g., setting a current mark position as a measurement start position, becomes impossible, thus degrading the usability.

It is an object of the present invention to provide a scale indication apparatus which is user-friendly and superior in the multiusability and a flow meter having this scale indication apparatus.

### SUMMARY OF THE INVENTION

In order to achieve this aim, according to the present invention, there is provided a scale indication apparatus comprising: a dial rotatably attached to a measurement apparatus which can not be externally operated; and a scale member for reading the displacement magnitude of an indicator of the measurement apparatus, wherein a scale indication position can be sequentially moved to reset the displacement magnitude of the indicator by rotating the dial in a first direction without moving the dial along an axial direction, and the dial can be moved along the axial direction to be removed from the measurement apparatus by the rotational operation in a second direction opposite from the first direction.

Since the indicator of the measurement apparatus is rotationally displaced in accordance with integration of measurement values, an integrated value of measured flow quantities is indicated by the rotational displacement magnitude of the indicator. When the dial of the scale indication apparatus is rotated in the first direction, a position of the scale member relative to the indicator varies and a zero position of the scale can be matched with the current position of the indicator. That is, the displacement magnitude of the indicator can be reset. Since the dial is not moved in the axial direction even if it is rotated in the first direction, the dial does not come off the measurement apparatus. However, when the dial is rotated in the second direction opposite from the first direction, the dial is moved along the axial direction to come off the measurement apparatus.

Thus, the displacement magnitude of the indicator can be reset to then start measurement, which improves the usability of the scale indication apparatus. Additionally, attachment and detachment of the dial can be easily performed, which also enhances the usability of the scale indication apparatus.

Further, according to the present invention, there is provided a scale indication apparatus, wherein the dial is attached to the measurement apparatus by a partially formed multiple thread structure, and a impetus giving member by which impetus acts in a direction away from the measurement apparatus is provided at a rotation center position of the dial.

Therefore, even if the dial is rotated in the first direction, this rotation direction is opposite from a meshing direction of the multiple thread structure, and the dial is not moved in the axial direction because the multiple thread structure is used. On the other hand, rotation of the dial in the second direction is concordant with the meshing direction of the multiple thread structure. Furthermore, the impetus giving means constantly gives impetus to the dial in a direction for meshing the multiple thread structure. With these members, when an internal thread portion and an external thread portion in the multiple thread structure coincide with each other by rotation of the dial in the second direction, the internal thread portion and the external thread portion are engaged with each other by the impetus of the impetus giving means. When the dial is further rotated in the second direction, rotation of the dial is converted into movement in the axial direction by the action of the multiple thread structure, thereby moving the dial in the axial direction.

Therefore, the dial can be attached and detached by only rotating the dial, thus improving the usability of the scale indication apparatus. Furthermore, since the impetus giving member by which the impetus acts in a direction away from the measurement apparatus is provided at the rotation center position of the dial, the multiple thread structure can be meshed by utilizing the impetus of the impetus giving member, and the dial can hardly come off the measurement apparatus.

Moreover, according to the scale indication apparatus of the present invention, a scale member is accommodated between the scale indication apparatus and the measurement apparatus and is detachably provided. Accordingly, the scale member can be replaced.

Thus, a polluted scale member can be replaced with a clean scale member, and a user can not feel repulsion when the scale indication apparatus is used in a flow meter of a water purifier in particular. In addition, the scale can be changed by only replacing the scale member with a different type of the scale member, which improves the multiusability of the scale indication apparatus.

Additionally, according to the present invention, there is provided a flow meter comprising: a measurement apparatus which causes rotational displacement of an indicator in accordance with passage of a fluid and can not be externally operated; and a scale indication apparatus defined in claim 1, thereby indicating an integrated flow quantity between the indicator and a scale member of the scale indication apparatus. Therefore, there is provided a flow meter which is superior in the versatility and the usability in that an integrated flow quantity to be indicated can be arbitrarily changed by only replacing the scale indication apparatus for example.

Furthermore, the flow meter according to the present invention is attached to a water purifier or a filter cartridge of a water purifier and measures an integrated flow quantity subjected to a water purifying process. Accordingly, a user can be aware of timing for cartridge replacement based on a measured value of the flow meter.

### BRIEF DESCRIPTION OF THE DRAWINGS

FIG. 1 is a cross-sectional view showing an example of an embodiment of a flow meter to which the present invention is applied; FIG. 2 is a plane view of the flow meter in FIG. 1; FIG. 3 is a side view of a dial of a scale indication apparatus to which the present invention is applied; FIG. 4 is a plane view of the dial of the scale indication apparatus in FIG. 3; FIG. 5 is a plane view of a scale member of the scale indication apparatus in FIG. 3; FIG. 6 is an enlarged cross-sectional view showing a projection and a concave portion of the flow meter in FIG. 1; FIG. 7 is a view showing actuation of an internal tooth planet gear train of the flow meter in FIG. 1 and a reference position of each gear; FIG. 8 is a view showing actuation of the internal tooth planet gear train of the flow meter in FIG. 1 and the state in which an internal gear circulates only 72 degrees from the state illustrated in FIG. 7; FIG. 9 is a view showing actuation of the internal tooth planet gear train of the flow meter in FIG. 1 and the state in which the internal gear circulates only 72 degrees from the state illustrated in FIG. 8; FIG. 10 is a view showing actuation of the internal tooth planet gear train of the flow meter in FIG. 1 and the state in which the internal gear circulates only 72 degrees from the state illustrated in FIG. 9; FIG. 11 is a view showing actuation of the internal tooth planet gear train of the flow meter illustrated in FIG. 1 and the state in which the internal gear circulates only 72 degrees from the state depicted in FIG. 10; FIG. 12 is a view showing actuation of the internal tooth planet gear train of the flow meter in FIG. 1 and the state in which the internal gear circulates only 72 degrees from the state illustrated in FIG. 11, namely the internal gear circulates to go into only one 360-degree roll from the state depicted in FIG. 7; FIG. 13 is a plane view showing a cover of a measurement apparatus; FIG. 14 is a cross-sectional view showing the cover of the measurement apparatus; FIG. 15 is a front view of a multiple thread structure; FIG. 16 is a plane view showing another example of the scale member; and FIG. 17 is a plane view showing still another example of the scale member.

### BEST MODE FOR CARRYING OUT THE INVENTION

The structure of the present invention will now be described hereinafter based on the illustrative best mode.

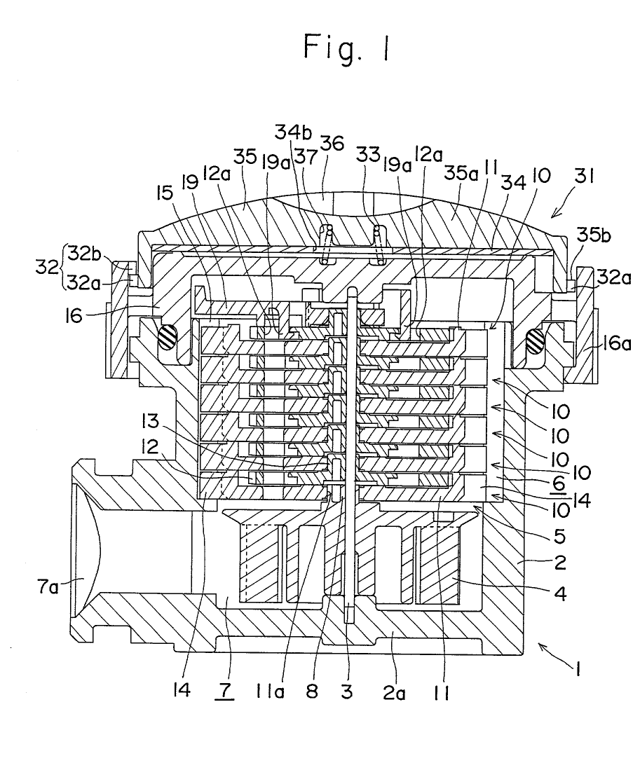

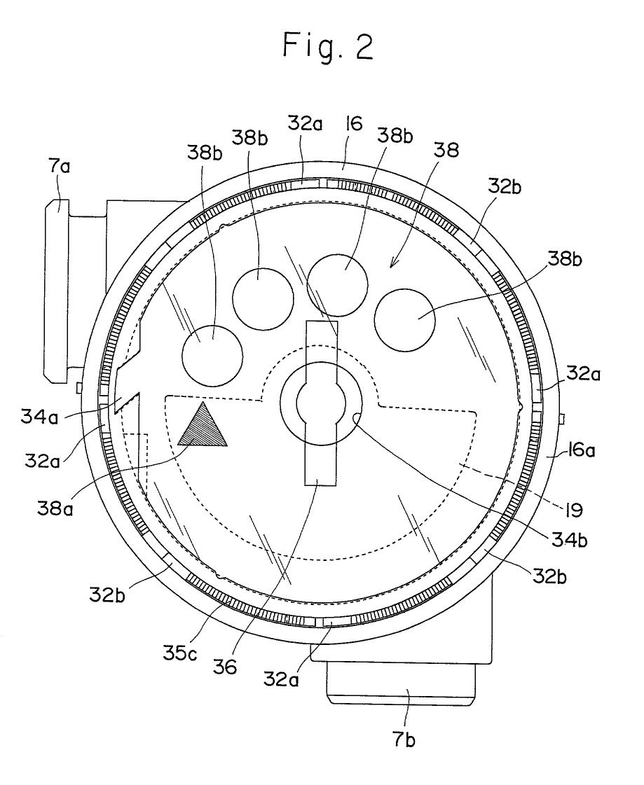

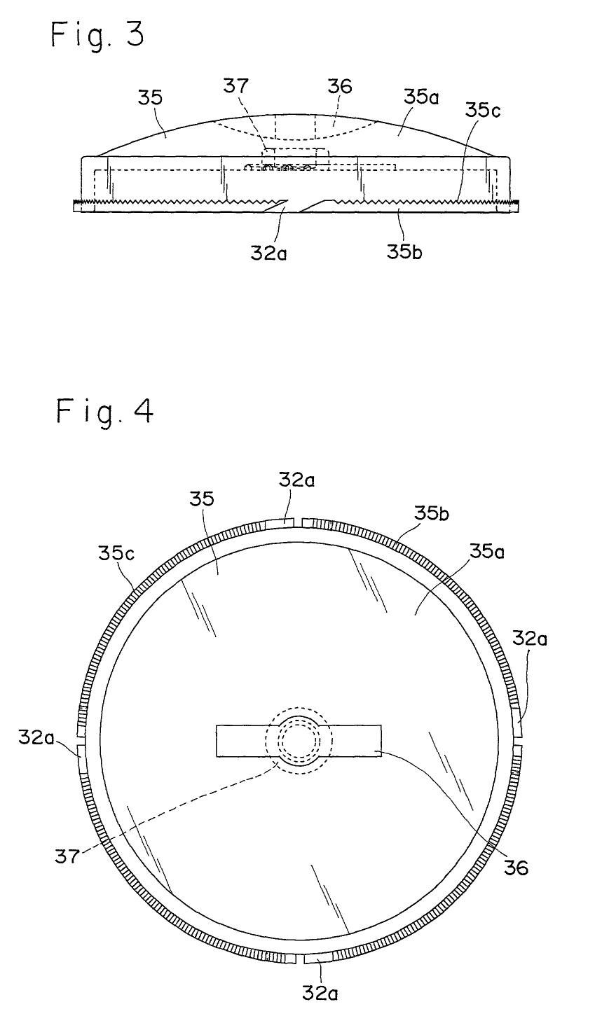

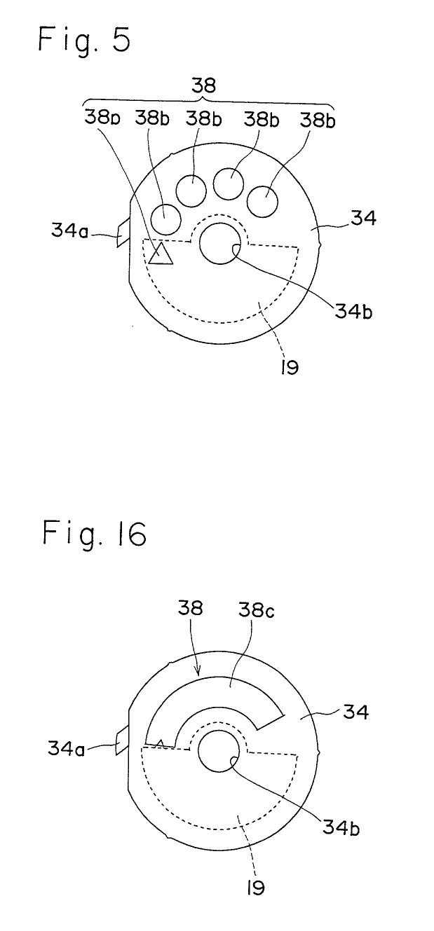

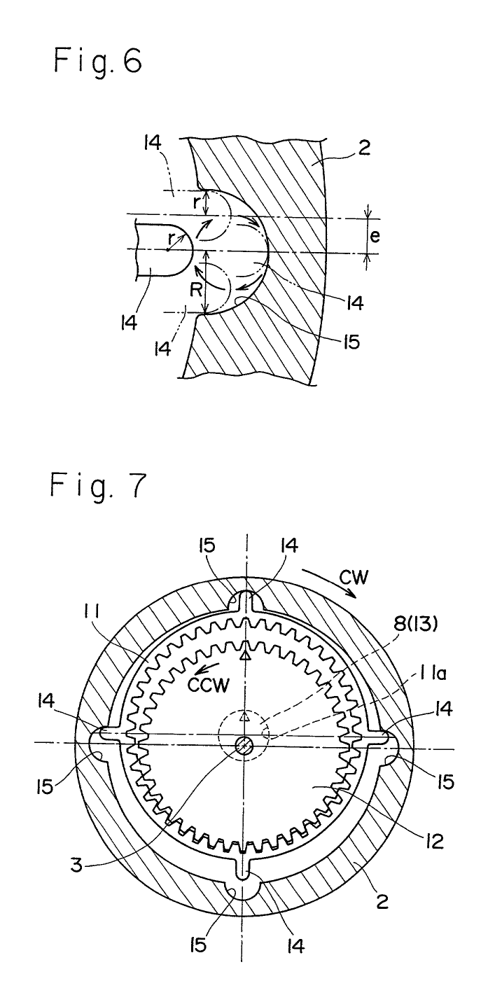

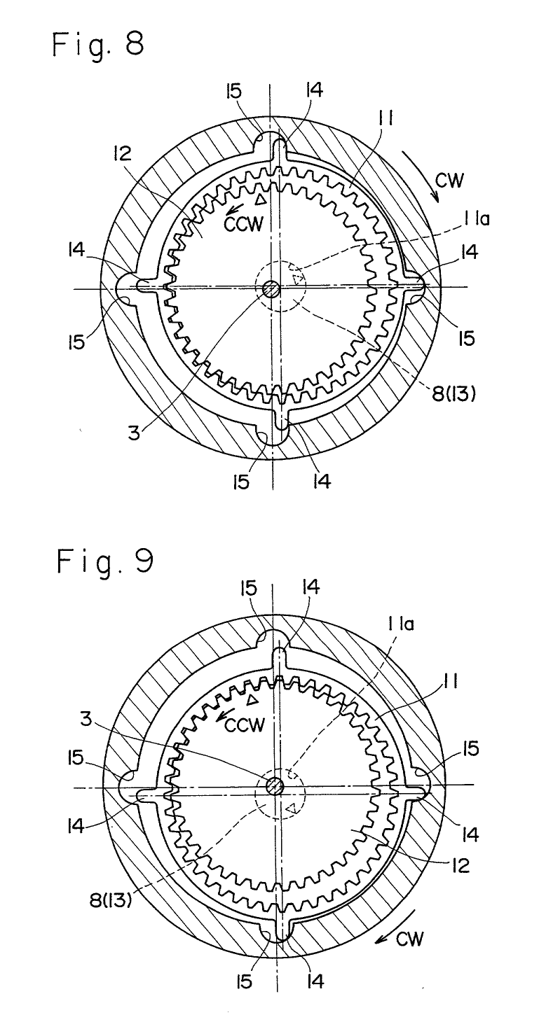

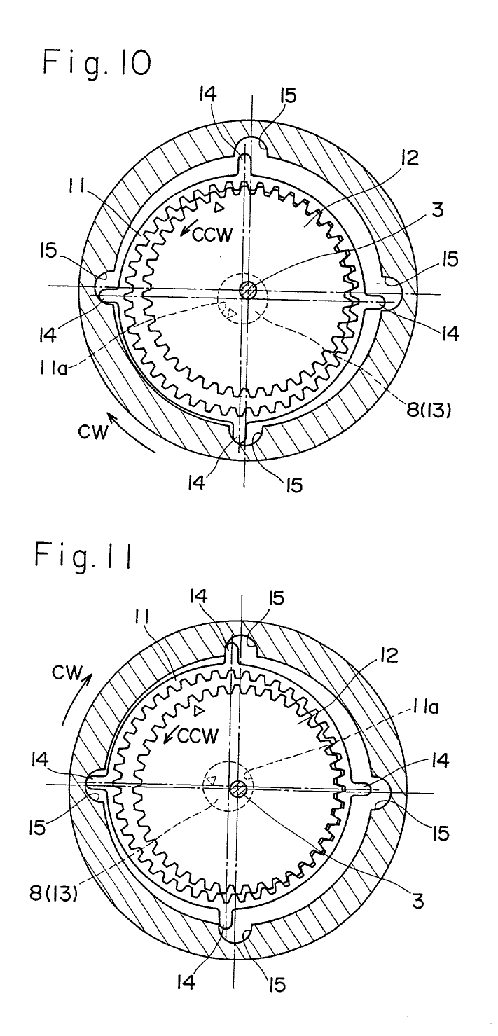

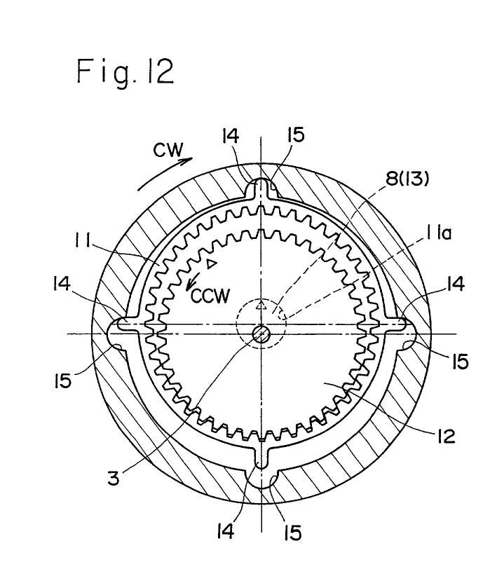

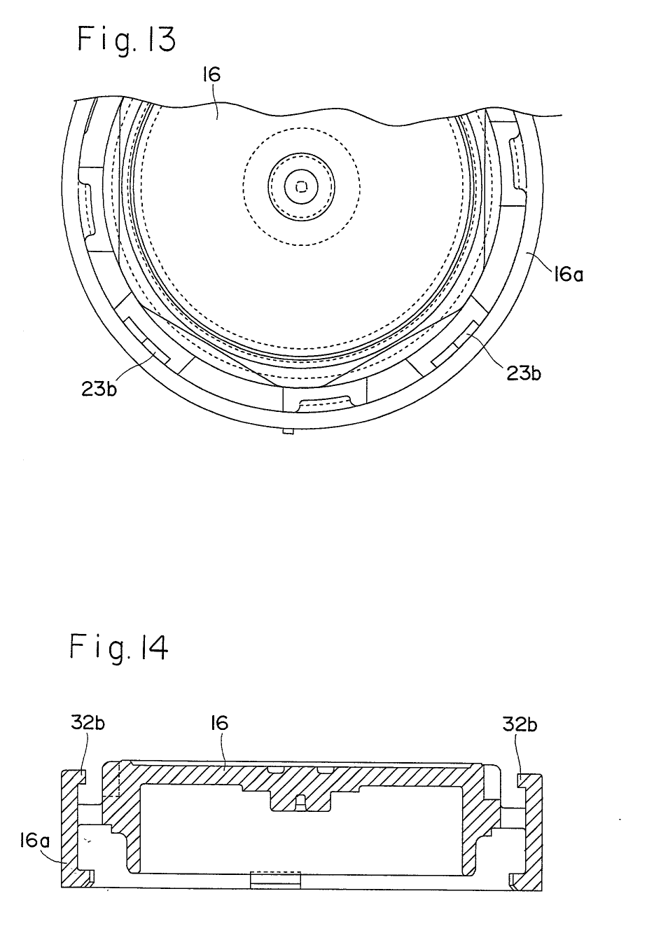

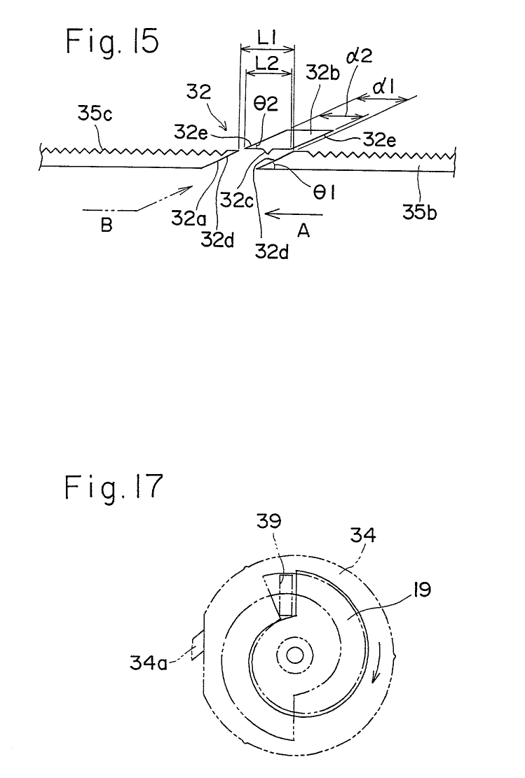

FIGS. 1 and 2 show an example of an embodiment of a flow meter to which the present invention is applied. This flow meter is constituted by comprising a measurement apparatus 1 and a scale indication apparatus 31. The scale indication apparatus 31 includes a dial 35 rotatably attached to the measurement apparatus 1 which can not be externally operated, and a scale member 34 for reading the displacement magnitude of an indicator 19 of the measurement apparatus 1. The scale indication apparatus 31 can sequentially move a scale indication position to reset the displacement magnitude of the indicator 19 by rotating the dial 35 in a first direction without moving the dial 35 in an axial direction, and can remove the dial 35 from the measurement apparatus 1 by rotating the dial 35 in a second direction opposite from the first direction to be moved in the axial direction.

The scale indication apparatus 31 has the dial 35 being attached to the measurement apparatus 1 by a partially formed multiple thread structure 32, and an impetus giving member 33 by which impetus can act in a direction away from the measurement apparatus 1 at a rotation center position of the dial 35. Further, a scale member 34 of the scale indication apparatus 31 is accommodated between the scale indication apparatus 31 and the measurement apparatus 1 and is detachably provided.

The dial 35 of the scale indication apparatus 31 has a cap-like shape as shown in FIGS. 3 and 4, and a central portion of the dial 35 is thicker than an outer peripheral portion of the same by flatly forming a bottom surface of a top board 35a and spherically forming a top surface of the same. A groove 36 is formed at the center of the top surface by utilizing this thick portion. Therefore, by applying and twisting a coin or the like in this groove 36, the dial 35 can be rotated in the first direction or the second direction. Moreover, an annular groove 37 is formed at the center of the bottom surface of the dial 35, and a coil spring 33 as an impetus giving member is fit in this annular groove 37.

The dial 35 is molded by transparent plastic, and the scale member 34 fitted in the bottom surface of the top board 35a or the indicator 19 of the measurement apparatus 1 can be seen from the outside of the dial 35. The scale member 34 is a white circular sheet made of, e.g., paper and, as shown in FIG. 5, one triangular hole 38a and four circular holes 38b are provided along the circumferential direction as the scale 38. In addition, by providing a pair of notches having shapes different from each other to the outer edge of the scale member 34 in the circumferential direction at intervals, a variant form portion 34a having a shape different from that of any other area is formed. When the scale member 34 is reversed, the variant shape portion 34a is turned, and a person who replaces the scale member 34 can readily identify the front and back sides of the scale member 34 based on a direction of the variant shape portion 34a. In addition, a hole 34b for inserting the impetus giving member 33 therethrough is provided at the center of the scale member 34.

Fine irregularities 35c are integrally molded on the top surface of a flange 35b of the dial 35. Further, the flange 35b forms grooves diagonally notched at four positions aligned in, for example, the circumferential direction at equal intervals, and this groove portion constitutes an internal thread portion 32a of the multiple thread structure 32. On the other hand, an external thread portion 32b of the multiple thread structure 32 is formed to a cover 16 of the measurement apparatus 1 shown in FIGS. 13 and 14 in detail. This external thread portion 32b is a claw piece formed on the inner peripheral surface of a surrounding wall 16a of the cover 16 and provided at, for example, four positions in accordance with the internal thread portions 32a. The multiple thread structure 32 does not require long threads, and very short threads can suffice this structure. Thus, as shown in FIG. 15, the shape of the external thread portion 32b seen from the front forms a parallelogram which is a part of the thread. Moreover, a convex portion 32c corresponding to the irregularities 35c formed to the flange 35b of the dial 35 is integrally molded on the bottom surface of the external thread portion 32b. Incidentally, as the multiple thread structure 32, one which can move the dial 35 in the axial direction of the dial 35 with respect to the cover 16 by sliding an inclined plane 32d provided to the dial 35 and an inclined plane 32e provided to the cover 16 can suffice this structure. That is, as the multiple thread structure 32, one which includes at least the inclined plane 32e provided to the cover 16 and the inclined plane 32d provided to the dial 35 and slides the inclined plane 32d provided to the dial 35 with respect to the inclined plane 32e provided to the cover 16 to cause the dial 35 to move in the axial direction of the dial 35, can suffice this structure, and a so-called cam my be used for this structure. It is good enough that the inclined plane 32e provided to the cover 16 and the inclined plane 32d provided to the dial 35 are formed to have at least a length capable of attaching or detaching the dial 35 to or from the cover 16. Additionally, although each of the internal thread portions 32a and the external thread portions 32b is provided at, for example, four positions, the number of positions at which each of the internal thread portion 32a and the external thread portion 32b is provided is not restricted to four. For example, they may be provided at two or three positions, or five or more positions, or one position, respectively.

It is to be noted that a width α1 of the internal thread portion 32a is slightly larger than a width α2 of the external thread portion 32b and a gap L1 of the internal thread portion 32a is slightly larger than a gap L2 of the external thread portion 32b. In addition, it is desirable that an angle θ1 of the internal thread portion 32a is equal to an angle θ2 of the external thread portion 32b. In this case, when the position of the external thread portion 32b is matched with the position of the internal thread portion 32a by rotating the dial 35, they don't come off all at once, and considerable rattling does not occur. The external thread portion 32b smoothly moves over the groove of the internal thread portion 32a, or both thread portions 32a and 32b engage with each other, and rotary movement of the dial 35 is converted into movement in the axial direction.

The measurement apparatus 1 is mainly constituted by a housing 2, a support shaft 3, an impeller 4 and a speed reduction mechanism 5.

The support shaft 3 is accommodated in a space 6 in the housing 2. This support shaft 3 is arranged at the center of the housing 2 and fixed by being pressed into a hole provided to a bottom wall 2a of the housing 2. To the support shaft 3 is attached the impeller 4 with a gap allowing rotation of the impeller 4. A boss 8 arranged so as to be eccentric from the support shaft 3 (which will be referred to as an eccentric boss) is integrally molded on the surface of the impeller 4 on the speed reduction mechanism 5 so as to protrude. The center of the eccentric boss 8 is eccentric from the center of the support shaft 3, i.e., the center of the impeller 4 by a distance e as shown in FIG. 7. It is to be noted that a lightening portion is formed to the eccentric boss 8 of the impeller 4 in order to eliminate deviation of a gravity point involved by provision of the eccentric boss 8. Furthermore, the eccentric boss 8 is rotatably fitted in and connected to a hole 11a of the internal gear 11 of the internal tooth planet gear mechanism 10 in a first stage of the speed reduction mechanism 5 arranged on the same axis as the impeller 4. The internal gear 11 has a disc-like shape and forms internal teeth on the rim portion thereof. Moreover, to the central portion of the internal gear 11 is provided with a hole to which an eccentric boss 13 of a sun gear 12 (eccentric boss 8 of the impeller 4 in case of the internal gear in the lowermost layer) arranged in the lower portion is rotatably fitted.

A fluid passage 7 through which a fluid to be measured passes in the housing 2 is formed on the bottom portion in the housing 2, and the impeller 4 is arranged in the middle of the fluid passage 7. Therefore, the impeller 4 is rotated by the fluid flowing from an inlet port 7a to an outlet port 7b.

The speed reduction mechanism 5 is accommodated in a space above the fluid passage 7 in the housing 2 and constituted by sequentially layering multi-stage internal tooth planet gear mechanism 10. In this embodiment, the speed reduction mechanism 5 includes, for example, six stages of internal tooth planet gear mechanisms 10, . . . , 10. Each internal tooth planet gear mechanism 10 is provided with the internal gear 11, the sun gear 12 and the eccentric boss 13, and the respective internal tooth planet gears are sequentially connected to each other by fitting the eccentric boss 13 provided to the sun gear 12 into a hole 11a formed to the internal gear 11 of the internal tooth planet gear mechanism 10 of the next stage. It is to be noted that the support shaft 3 is provided so as to pierce the eccentric boss 13 of each sun gear 12.

The internal gear 11 has a diameter such that a small gap is formed between the internal gear 11 and the inner surface of the housing 2 forming the space 6 around the internal gear 11, and is capable of circulating around the support shaft 3 with respect to the housing 2 but can not rotate around the eccentric bosses 8 and 13. Giving concrete description, a plurality of protrusions 14 protruding in the radial direction are integrally molded on the outer peripheral surface of the internal gear 11. On the other hand, a concave portion 15 is provided on the inner surface of the housing 2 at a position corresponding to each protrusion 14. Each concave portion 15 is a groove which is formed in parallel with the support shaft 3 and can accommodate therein all the protrusions 14 of the internal gear 11. Each protrusion 14 is inserted in the corresponding concave portion 15. The shape of an end of each protrusion 14 seen in plan is a semicircle having a radius of r as shown in FIG. 6. In addition, the part forming the concave portion 15 of the housing 2 has a semicircular shape having a radius of R. These radii satisfy the relationship of R=r+e. Therefore, the end of each protrusion 14 can circulate inside the concave portion 15 of the housing 2, and the internal gear 11 can circulate around the support shaft 3 with a quantity of eccentricity e as a radius. However, all the protrusions 14 provided at four positions on the circumference do not simultaneously come off the concave portion 15, and some of the protrusions 14 are necessarily engaged with the housing 2. Therefore, the internal gear 11 can not rotate on its axis. A hole 11a is formed at the center of the internal gear 11. Additionally, the number of teeth Z1 of a gear portion 11b in the internal gear 11 is set to a predetermined value.

The sun gear 12 is arranged inside of the gear portion 11b of the internal gear 11 and meshes with the gear portion 11b. The number of teeth Z2 of the sun gear 12 is set to a predetermined value. For example, in this embodiment, the number of teeth Z1 of the internal gear 11 is set to a value 44, and the number of teeth Z2 of the sun gear 12 is set to a value 40. Therefore, a speed reduction ratio i of rotation transmitted from the internal gear 11 to the sun gear 12 is expressed as i=(Z1-Z2)÷Z2=(44−40)÷40 and equals to a value 0.1. In addition, a lightening portion is provided to the eccentric boss 13 of the sun gear 12 in order to eliminate deviation of the gravity point involved by provision of the eccentric boss 13.

The eccentric boss 13 of the sun gear 12 is integrally molded on the surface of the internal tooth planet gear mechanism 10 of the next stage. The center of this eccentric boss 13 is eccentric from the center of the sun gear 12, namely, the support shaft 3 by a distance e as similar to the eccentric boss 8 formed to the impeller 4. The eccentric boss 13 is fitted in the hole 11a at the center of the internal gear 11 constituting the internal tooth planet gear mechanism 10 of the next stage so as to be capable of effecting relative rotation and rotatably connects them. Therefore, the eccentric boss 13 and the internal gear 11 of the internal tooth planet gear mechanism 10 of the next stage are integrated to perform the circular movement.

Incidentally, the eccentric boss 8 of the impeller 4 is fitted in the hole 11a of the internal gear 11 constituting the internal tooth planet gear mechanism 10 of the first stage, and the internal gear 11 and the eccentric boss 8 are thereby connected to each other so as to be capable of relatively rotating. Therefore, the internal gear 11 of the internal tooth planet gear mechanism 10 of the first stage and the eccentric boss 8 of the impeller 4 are integrated to effect the circular movement.

Further, the indicator 19 is attached to the sun gear 12 of the internal tooth planet gear mechanism 10 by hooking the claw piece 19a. The indicator 19 is, for example, a semicircular plate, and the two claw pieces 19a are integrally molded on the bottom surface thereof. When these claw pieces 19a are inserted through the holes 12a of the sun gear 12 and hooked on the sun gear 12, the indicator 19 is attached to the sun gear 12 to be integrally rotated. That is, the rotational displacement magnitude of the indicator 19 is in proportion to a flow quantity of a fluid to be measured by the measurement apparatus 1. The indicator 19 is colored in a striking color such as red.

The flow meter of this embodiment having the above-described structure operates as follows.

The measurement apparatus 1 of this flow meter is installed in, for example, a water purifier for filtering tap water. A fluid (tap water) filtered by the water purifier flows in the fluid passage 7 in the housing 2 to rotate the impeller 4 and then flows from an outlet port 7b to the outside of the housing 2.

On the other hand, rotation of the impeller 4 is transmitted to the speed reduction mechanism 5. That is, the eccentric boss 8 circulates around the support shaft 3 by rotation of the impeller 4 to cause the circular movement of the internal gear 11 in the internal tooth planet gear mechanism 10 of the first stage of the speed reduction mechanism 5. FIGS. 7 to 12 show the state in which the circular movement of the internal gear 11 is converted into rotation of the sun gear 12 while reducing the speed. It is to be noted that a triangular mark is given in each of FIGS. 7 to 12 for facilitating understanding rotation of the internal gear 11, the eccentric boss 8 and the sun gear 12.

The case where the eccentric boss 8 and the internal gear 11 start the circular movement from the positions shown in FIG. 7 in the clockwise direction (CW direction) will now be considered. As shown in FIG. 8, when the eccentric boss 8 and the internal gear 11 circulate only 72 degrees (⅕ rotation) in the CW direction in the drawing from this state, the sun gear 12 rotates around the support shaft 3 in the counterclockwise direction (CCW direction) in the drawing. In this case, the speed of the circular motion of the internal gear 11 is reduced with the speed reduction ratio 0.1, and this circular motion causes the sun gear 12 to rotate for a distance corresponding to a difference in number of teeth from the internal gear 11. Then, when the internal gear 11 and others perform further circular motion in the CW direction in the drawing, the sun gear 12 rotates in the CCW direction in the drawing while reducing its speed as sequentially shown in FIGS. 9 to 12. It is to be noted that FIGS. 7 to 12 show the state in which the internal gear 11 effects the circular motion for each 72 degrees.

Subsequently, as shown in FIG. 12, when the circular motion of the internal gear 11 reaches 360 degrees, the speed ratio (speed reduction ratio) i of the internal tooth planet gear mechanism 10 is set to a value 0.1. Therefore, the sun gear 12 rotates only 36 degrees in the CCW direction in the drawing. Accordingly, the eccentric boss 13 formed to the sun gear 12 also performs the circular motion only 36 degrees in the same direction. Since this eccentric boss 13 is fitted in the hole 11a of the internal gear 11 of the internal tooth planet gear mechanism 10 of the next stage, the internal gear 11 of the internal tooth planet gear mechanism 10 of the next stage also carries out the circular motion only 36 degrees.

That is, the rotation of the impeller 4 is reduced to 1/10 rotation in the internal tooth planet gear mechanism 10 of the first stage in speed. The rotation of the impeller 4 in the internal tooth planet gear mechanism 10 of each stage is also reduced to 1/10 rotation in speed.

Further, the rotation of the impeller 4 transmitted by the internal tooth planet gear mechanism 10 of each stage while reducing the speed is transmitted from the sun gear 12 of the internal tooth planet gear mechanism 10 of the last stage to the indicator 19. Since one rotation of the impeller 4 is associated with a predetermined flow quantity in the fluid passage 7, the rotational displacement magnitude of the indicator 19 is in proportion to an integrated flow quantity in the fluid passage 7. At least the dial 35 and the cover 16 are transparent, and the rotational displacement magnitude of the indicator 19 can be read from the outside of the dial 35 through the circular holes 38b of the scale 38 of the scale member 34. That is, since the indicator 19 rotates with respect to the scale member 34 which remains stationary, it is possible to measure the integrated flow quantity in the fluid passage 7, i.e., the integrated quantity of the fluid which has flowed through the fluid passage 7 based on this rotational displacement magnitude. Incidentally, in this embodiment, the indicator 19 is colored in red and the scale member 34 is colored in white, the displacement magnitude of the indicator 19 can be clearly and accurately read.

The scale corresponding to an integrated flow quantity which is desired to be measured is provided to the scale member 34. In the scale member 34 shown in FIG. 5, the respective holes 38a and 38b are formed in such a manner that the integrated flow quantity which is desired to be measured is attained upon displacement from a position at which the indicator 19 can be seen from only the triangle hole 38a (measurement start position) to another position at which the indicator 19 can be seen from all the circular holes 38b (measurement end position). Since the scale member 34 is fitted in the inner surface of the dial 35 so as to disable relative rotation and integrally rotates with the dial 35, rotating the dial 35 in the first direction can move the position of the scale 38 with respect to the indicator 19. Therefore, by rotating the dial 35 in the first direction before starting measurement, the scale 38 is set at the measurement start position. It is to be noted that the first direction is a direction that the dial 35 can be moved close to the cover 16 when the internal thread portion 32a and the external thread portion 32b in the multiple thread structure 32 are meshed with each other and that the internal thread portion 32a and the external thread portion 32b are not meshed with each other when the dial 35 is attached to the cover 16. Further, the second direction which is opposite from the first direction is a direction that the dial 35 can be moved away from the cover 16 when the internal thread portion 32a and the external thread portion 32b in the multiple thread structure 32 are meshed with each other and that the internal thread portion 32a and the external thread portion 32b are meshed with each other when the dial 35 is attached to the cover 16.

In case of rotating the dial 35 in the first direction indicated by an arrow A in FIG. 15, the direction of rotation is opposite from the meshing direction of the multiple thread structure 32. Thus, the internal thread portion 32a and the external thread portion 32b are not meshed with each other, and the dial 35 does not move along the axial direction of the dial 35 to come off the measurement apparatus 1.

On the contrary, when the dial 35 is rotated in the second direction indicated by an arrow B in FIG. 15 which is opposite from the first direction, since the direction of rotation is the meshing direction of the multiple thread structure 32, the dial 35 moves along the axial direction of the dial 35 to come off the measurement apparatus 1 by the behavior of the multiple thread structure 32. At this time, since impetus is given to the dial 35 by the coil spring 33, the external thread portion 32b and the internal thread portion 32a start to be meshed with each other when they are opposed to each other. Therefore, only rotating the dial 35 in the second direction causes the external thread portion 32b and the internal thread portion 32a to be meshed with each other, thereby detaching the dial 35 from the measurement apparatus 1. Accordingly, the scale member 34 can be replaced and the fouling inside the dial 35 can be removed. Further, when the scale member 34 is replaced with a different type of the scale member, an integrated flow quantity to be measured can be changed.

On the other hand, in order to attach to the measurement apparatus 1 the dial 35 which has been removed from the measurement apparatus 1, the flange 35b of the dial 35 is inserted into the surrounding wall 16a of the cover 16 and the internal thread portion 32a and the external thread portion 32b are opposed to each other. Thereafter, the dial 35 is screwed in the cover 16 against the impetus of the coil spring 33 while rotating the dial 35 in the first direction. Then, when the flange 35b passes through the internal thread portion 32b to move under the external thread portion 32b, the flange 35b is supported by the external thread portion 32b from the upper side. As a result, the dial 35 is rotatably attached to the cover 16 of the measurement apparatus 1 with a small gap therebetween. In this state, the coil spring 33 demonstrates the impetus in a direction for lifting up the flange 35b to be pressed against the external thread portion 32b, and the irregularities 35c are formed on the top surface of the flange 35b while the convex portion 32c is formed on the bottom surface of the external thread portion 32b. Therefore, appropriate frictional force is generated on the sliding surfaces of the flange 35b and the external thread portion 32b, and a sense of moderation is produced at the time of rotating the dial 35. Moreover, it is possible to prevent the dial 35 from rotating due to vibrations and the like.

In this flow meter, since a screw and the like is not used for attaching the scale indication apparatus 31, the flow meter can be reduced in dimension and width, and the number of components of the flow meter can be decreased. Further, since another component such as a mounting screw is not used, the component can not be lost, and a special tool such as a screw driver is not required. Thus, the dial 35 can be rotated if there is a thin plate-like material such as a coin. In addition, since another component such as a mounting screw which covers a part of the scale is not used, it can avoid that the scale 38 can not be seen by the mounting screw or the like. Consequently, a visually visible range of the scale member 34 can be widened. In addition, since the visually visible range can be enlarged, the dial 35 can be reduced in size.

Further, since the coil spring 33 gives impetus to the dial 35 in a direction away from the cover 16, the dial 35 can be readily detached from the cover 16 when removing the dial 35. Furthermore, the dial 35 is pushed against the external thread portion 32b formed to the cover by the impetus of the coil spring 33, and a sense of moderation can be hence produced. Moreover, appropriate frictional force is generated, thereby enabling rotation standstill of the dial 35 and fixation of the dial 35 to the cover 16.

This flow meter is incorporated in, for example, a domestic water purifier or a filter cartridge and used as indicating means for indicating a replacement timing for the filter. In this type of water purifier, the replacement timing for the filter is judged based on a quantity of tap water which has been filtered. That is, the flow meter is used for measuring an integrated flow quantity subjected to the water purifying process after attaching the measurement apparatus 1 to the domestic water purifier or the water purifier filter cartridge.

Before starting use of a new filter cartridge, the dial 35 of the scale indication apparatus 31 is rotated in the first direction to set a position of the scale member 34 to a measurement start position, i.e., a position at which the indicator 19 can be seen from only the triangular hole 38a. When the water purifier is started to be used, the indicator 19 rotates in accordance with a quantity of water which has been filtered, and the indicator 19 can be gradually seen from the circular holes 38b starting from the circular hole 38b close to the triangular hole 38a. Then, when an integrated flow quantity after replacement of the filter cartridge reaches a predetermined value, the indicator 19 can be seen from all the circular holes 38b. A user of the water purifier can be aware of the replacement timing for the filter cartridge by confirming the position of the indicator 19.

Then, after replacing the cartridge, by applying a coin or the like to the groove 36 and rotating the dial 35 in the first direction to further rotate the scale member 34, the position of the scale is again matched with the measurement start position. As a result, the displacement magnitude of the indicator 19 is reset, and measurement can be hence started from zero in the next measurement, and the integrated flow quantity which has used the filter cartridge can be accurately measured by confirming movement of the indicator 19 to the measurement end position.

As described above, since the displacement magnitude of the indicator 19 can be reset every time the filter cartridge is replaced, even if the replacement timing for the filter cartridge is upset and the scale overruns, measurement can be effected based on the scale in the next measurement without being affected by the overrun. Therefore, an accurate integrated flow quantity can be known and the displacement of the indicator 19 can be easily reset.

In addition, the integrated flow quantity until replacement of the filter cartridge may differ depending on types of water purifier. In such a case, replacing the scale member 34 with one having different intervals of the scale 38 enables measurement of a different integrated flow quantity. Accordingly, a range of an integrated water quantity which can be measured by the scale indication apparatus 31 can be enlarged.

Incidentally, although the above has described an example of the preferred embodiment according to the present invention, the present invention is not restricted thereto, and various modifications are possible without departing from the scope of the invention. For example, although one triangular hole 38a and four circular holes 38b are formed to the scale member 34 to provide the scale 38 in the above description, the number, shapes and dimensions of holes which can be the scale 38 are not of course restricted thereto. Additionally, as shown in FIG. 16, an arc-like hole 38c may be formed as the scale 38 of the scale member 34, for example.

Further, the shape of the indicator 19 may not be a semicircle. For example, as shown in FIG. 17, the indicator 19 may have such a shape as that the radius of the indicator 19 gradually changes. In this case, providing a hole 39 elongated in the radial direction to the scale member 34 as the scale 38 causes an area of the indicator 19 which can be seen from this hole 39 to gradually increase, and an integrated flow quantity can be measured based on an area of this part which can be seen.

Furthermore, although the internal thread portion 32a of the multiple thread structure 32 is provided to the flange 35b of the dial 35 and the external thread portion 32b is provided to the cover 16 in the above description, the external thread portion 32b may be provided to the flange 35b of the dial 35 and the internal thread portion 32a may be provided to the cover 16.

Moreover, the scale indication apparatus 31 may be rotatably attached to the measurement apparatus 1 by the multiple thread structure 32 in the above description, the present invention is not restricted thereto. For example, a claw hooked to the measurement apparatus 1 may be formed to the scale indication apparatus 31 so that the scale indication apparatus 31 is rotatably attached to the measurement apparatus 1 by hooking the claw to the measurement apparatus 1. In such a structure, the scale indication apparatus 31 can be likewise rotated with respect to the measurement apparatus 1 to reset the displacement magnitude of the indicator 19. Additionally, in this case, the displacement magnitude of the indicator 19 can be reset by rotating the scale indication apparatus 31 in any one of the first and second directions. In case of detaching the scale indication apparatus 31 from the measurement apparatus 1, removing the claw of the scale indication apparatus 31 from the measurement apparatus 1 can suffice. It is to be noted that the claw may be provided to the measurement apparatus 1 in place of providing the claw to the scale indication apparatus 31.

Further, although the scale member 34 is constituted as an independent member in this embodiment, the dial 35 may be scaled by printing or engraving so that the scale member 34 can be integrated with the dial 35 in some cases. In such a case, the scale member is replaced in accordance with each dial 35.

What is claimed is:

1. A scale indication apparatus comprising: a dial rotatably attached to a measurement apparatus which can not be externally operated; and a scale member for reading a displacement magnitude of an indicator of said measurement apparatus, wherein a scale indication position can be sequentially moved to reset the displacement magnitude of said indicator by rotating said dial in a first direction without moving said dial in an axial direction, and said dial can be moved in said axial direction to be detached from said measurement apparatus by rotating said dial in a second direction opposite from said first direction.

2. A scale indication apparatus according to claim 1, wherein said dial is attached to said measurement apparatus by a partially formed multiple thread structure, and an impetus giving member by which impetus acts in a direction away from said measurement apparatus is provided at a rotation center position of said dial.

3. A scale indication apparatus according to claim 1, wherein said scale member is accommodated between said scale indication apparatus and said measurement apparatus and is detachably provided.

4. A flow meter comprising: a measurement apparatus which causes rotational displacement of an indicator in accordance with passage of a fluid and can not be externally operated; and a scale indication apparatus defined in claim 1, wherein an integrated flow quantity is indicated between said indicator and a scale member of said scale indication apparatus.

5. A flow meter according to claim 4, wherein said flow meter is attached to a water purifier or a water purifier filter cartridge to measure an integrated flow quantity subjected to a water purifying process.
